(19) United States
(12) Patent Application Publication
(10) Pub. No.: US 2024/0117925 A1
(43) Pub. Date: Apr. 11, 2024

(54) EXTENDABLE SUPPORT APPARATUS

(71) Applicants: LARRY J. TIEFENBRUNN, Edison, NJ (US); Merin Swasey, North Logan, UT (US)

(72) Inventors: LARRY J. TIEFENBRUNN, Edison, NJ (US); Merin Swasey, North Logan, UT (US)

(21) Appl. No.: 18/211,263

(22) Filed: Jun. 18, 2023

Related U.S. Application Data
(60) Provisional application No. 63/414,485, filed on Oct. 8, 2022.

(51) Int. Cl. F16M 11/28; F16M 11/04; G03B 17/56

(52) U.S. Cl. CPC F16M 11/28; F16M 11/04; G03B 17/561

(57) ABSTRACT

Apparatus embodying the invention includes an extendable support member with a cap for mounting thereon a camera or any photographic equipment, or the like. In accordance with one aspect of the invention, the cap is formed with “threaded holes” for the attachment of selected accessories. To provide a high degree of flexibility the extendable support member may include selected inter-connectable sections for providing a combination of fixed and variable extensions. The selected sections may have different cross sectional areas. In accordance with the invention the cap is formed with different inner regions having different dimensions in order to mate with the different cross-sectional areas of the selected sections.

### CLAIM OF PRIORITY

This invention claims priority based on U.S. Provisional Application Ser. No. 63/414,485 filed Oct. 8, 2022 titled EXTENDABLE SUPPORT APPARATUS whose teachings are incorporated herein by reference.

### BACKGROUND OF THE INVENTION

This application relates to extendable support apparatus and in particular to extendable support apparatus for devices such as cameras, photographic equipment and any like device.

By way of example, a significant problem exists for photographers doing close-up photography such as used in food photography, macro and product photography. They need to hold their cameras at various heights depending upon the size and the desired magnification of the object being photographed. Thus there is a need for a support apparatus which can be easily adjusted to vary the height of the camera and to do so securely and reliably.

### SUMMARY OF THE INVENTION

Apparatus embodying the invention include an extendable support for a camera or any photographic equipment, or the like, with a cap having “dedicated holes” for enabling the attachment thereto of accessories for use with the camera or like photographic equipment.

Furthermore, to provide a high degree of flexibility the extendable support may include selected parts for providing a combination of fixed and variable extensions.

The selected parts may have different diameters or cross-sectional areas. In accordance with the invention, the cap with dedicated holes may include different inner regions in order to mate with the different diameters or cross-sectional areas of the selected parts.

### BRIEF DESCRIPTION OF THE DRAWINGS

In the accompanying drawings, which are not drawn to scale, like reference characters denote like components; and

FIG. 1 is an exploded view of the components forming an extendable support 100 embodying the invention;

FIGS. 1A, 1B, 1C, and 1D are simplified cross sectional views of selected components of FIG. 1 illustrating the nature of the components and some sub-assemblies;

FIG. 1E is a conceptual cross-sectional diagram of a cap embodying the invention illustrating inventing features of the cap;

FIGS. 1E1 and 1E2 are conceptual cross-sectional diagrams of a cap embodying the invention mated with different sized (diameters) components of the extendable support;

FIG. 1F is a view of the assembled components of FIG. 1 comprising an extendable support embodying the invention;

FIG. 2 is an isometric diagram of a cap embodying the invention mounted on a cylindrical support in accordance with the invention;

FIG. 2A is a cross sectional diagram of FIG. 2;

FIG. 3 is a cross sectional diagram of the un-extended extendable support device (as shown in FIG. 1F) embodying the invention;

FIG. 4 is a cross sectional diagram of a fully extended extendable support device embodying the invention;

FIG. 5 is an isometric drawing of the extendable support embodying the invention mounted on a tripod 400 with a camera mounted on the support 100; and

FIG. 6 is an isometric drawing of an extendable support embodying the invention with various accessories connected to threaded holes of the cap in accordance with the invention.

### DETAILED DESCRIPTION OF THE DRAWINGS

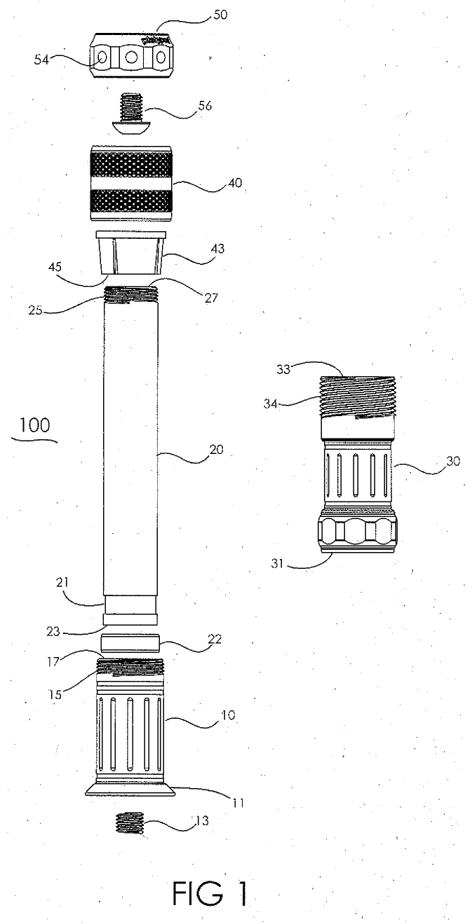

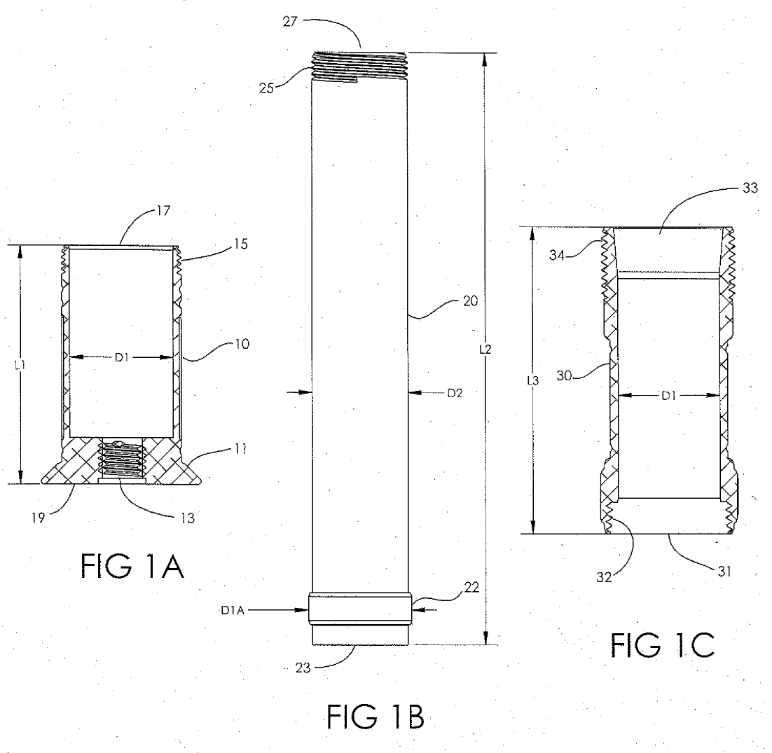

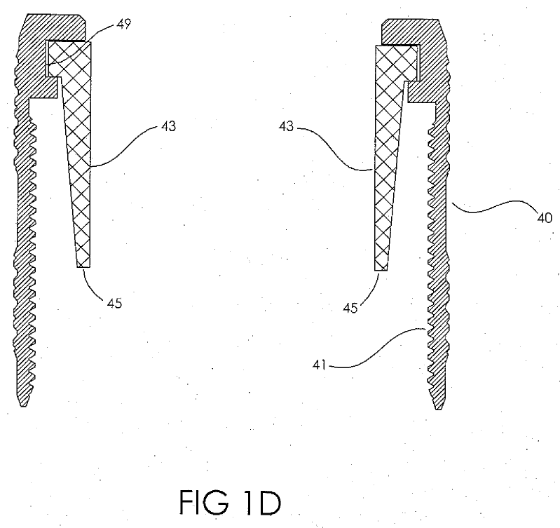

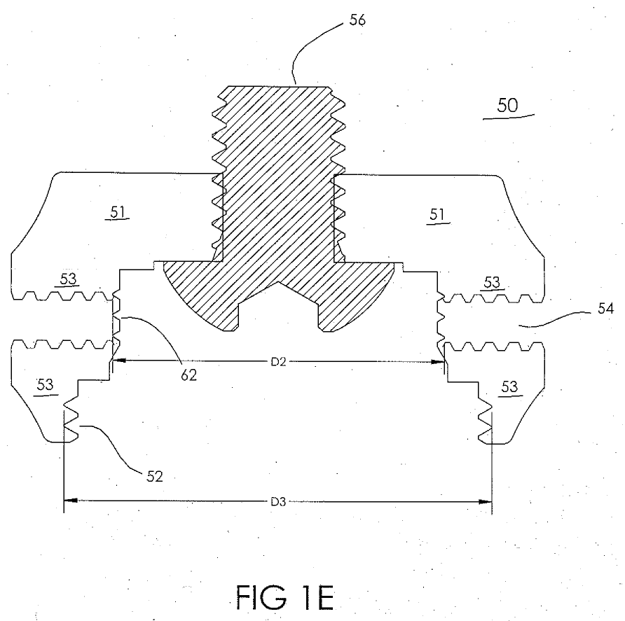

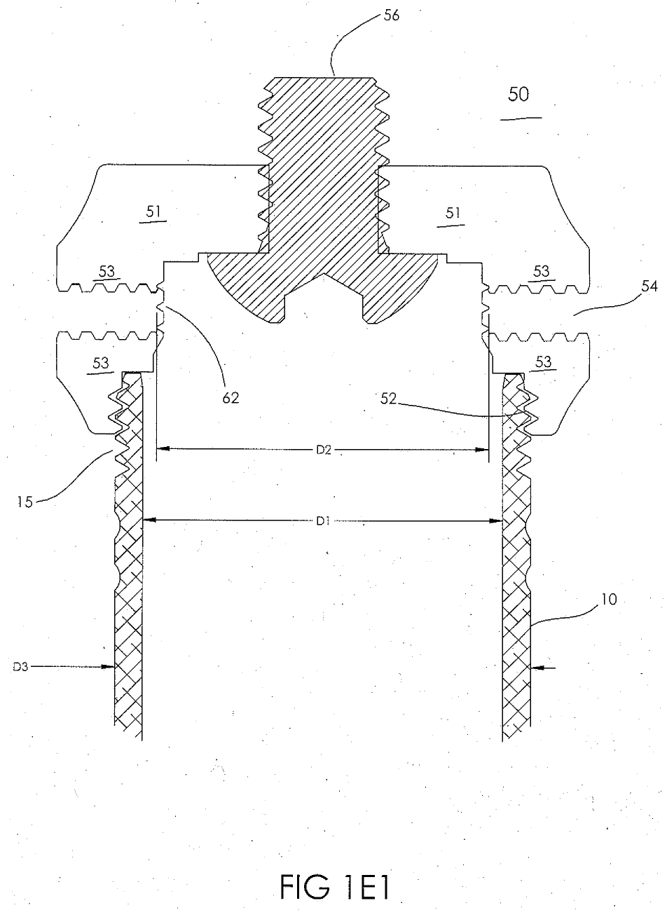

FIG. 1 is an exploded view of components forming an extendable support 100 embodying the invention. FIG. 1 shows the components of device 100 to include: a base cylinder section 10 with a base attaching screw 13, a cylindrical tubular section 20 with a ring 22, a cylindrical section 30, a cylindrical collar lock section 40 with a lock and stop mechanism 43 and a cap 50 with an attaching screw 56.

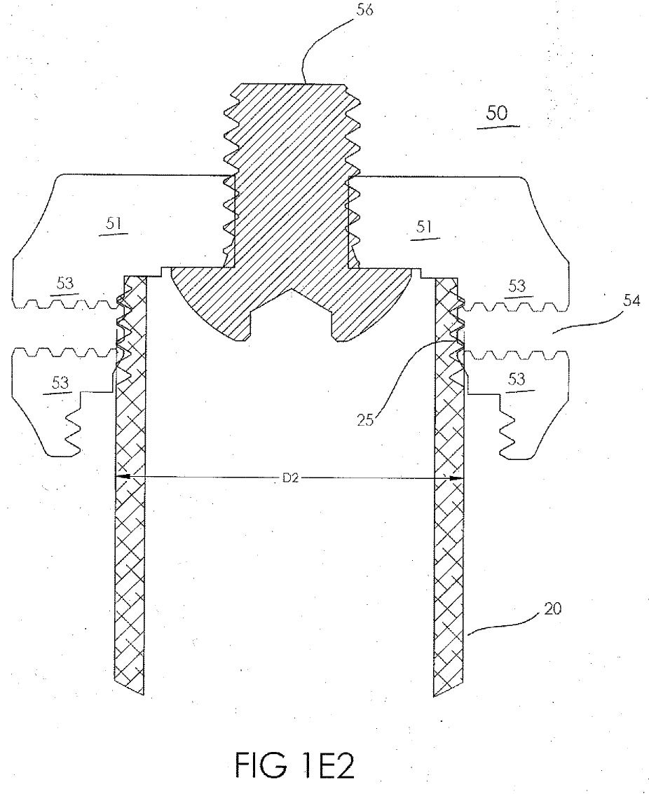

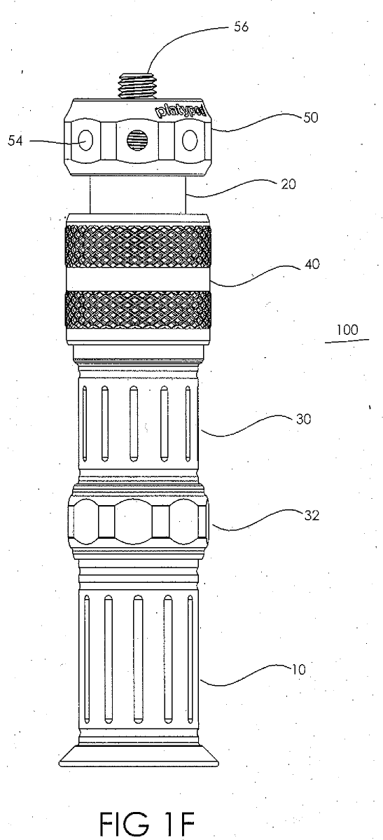

The base cylindrical section 10, which is also shown in cross-section in FIG. 1A, has a flared bottom 11 with a base attaching screw 13 to enable the attachment of the base section 10 to any selected base support as shown, for example, in FIG. 2. The attaching screw 13 is shown by way of example and any suitable attaching means could be used instead. Base cylindrical section 10 has a top end 17 and a bottom end 19 and has an outer (male) threaded section (also referred to as “region”) 15 formed below its top end 17. In one embodiment the length, L1, of the base cylindrical section 10 between top end 17 and the bottom end was 60 mm and its internal diameter, D1, was 26 mm.

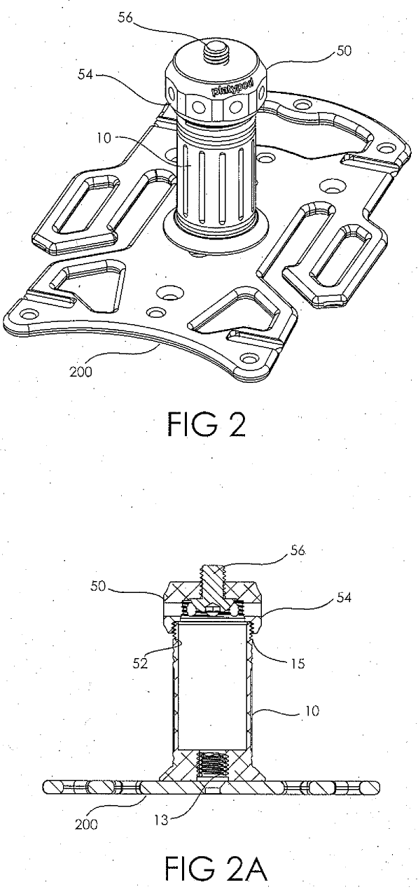

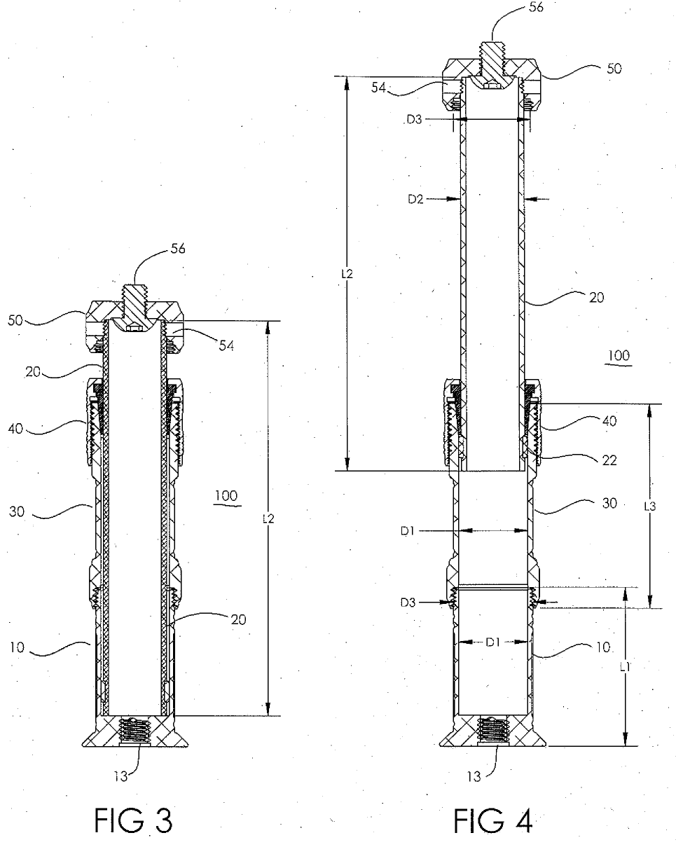

The cylindrical tubular section 20 which is also shown in cross section in FIG. 1B includes a notch 21 formed near its bottom end 23 and an external (male) threaded section (also referred to as “region”) 25 near its top end 27. In one embodiment the length, L2, of cylindrical section 20 between top end 27 and bottom end 23 was 150 mm, its internal diameter was 20 mm and its outer diameter, D2, was 24 mm. That is, the outer diameter D2 of section 20 is less than the inner diameter D1 of sections 10 and 30. The ring 22 is firmly mounted within the notch 21 and attached to tubular section 20. Tubular section 20 is designed to be moved up and down within sections 10 and 30 and to function as a variable extendable support as shown in FIGS. 3 and 4.

Ring 22 is fitted into notch 21 as shown in cross section in FIG. 1B. Ring 22 has an outer diameter D1A (which is fragmentally smaller than D1) so it fits snugly within cylindrical sections 10 and section 30 while still enabling section 20 to move up and down smoothly. Thus, ring 22 functions to: (a) enable cylindrical section 20 to move smoothly through the assembly of sections 10 and 30 while ensuring that the cylindrical section 20 remains centered at all times; and (b) provides a surface which stops the cylindrical section 20 from being pulled out of the assembly as described below. The ring may be formed of any suitable material such as, for example a plastic material.

Cylindrical tubular section 30 is also shown in cross section in FIG. 1C. The tubular section 30 has an inner diameter which is preferably equal to D1, although it could be greater than D1. In one embodiment the inner diameter of section 30 was 26 mm like the inner diameter of base section 10. Section 30 has a lower end 31 and a top end 33. An inner (female) threaded region 32 is formed near its lower end 31 which is designed to screw onto threaded section 15 of base section 10. Section 30 has an outer (male) threaded section 34 formed below its top end 33 which is designed to mesh with the inner threaded section of collar lock section 40.

In assembling cylindrical sections 10, 20 and 30, as shown in the Figures, section 20 can be inserted within section 10 and then section 30 can be screwed (or attached) to section 10 such that cylinder 20 with ring 22 can be moved up and down through tubular sections 10 and 30. Alternatively, sections 10 and 30 can be attached to each other and then section 20 can be inserted within the combined sections 10 and 30.

Cylindrical collar lock section 40 with lock and stop ferrule mechanism 43 inserted therein may be represented as shown in simplified conceptual cross-section FIG. 1D. Collar 40 includes a notch 49 for holding and retaining a stop and lock mechanism 43. Collar section 40 includes an inner (female) threaded region 41 at its lower end (as shown in FIG. 1D) designed to mesh with threaded region 34 of section 30. Ferrule 43 is inserted into collar section 40 and the combination (as may be deduced from FIGS. 3 and 4) functions to provide: (a) a stop mechanism with a stop 45 such that ring 22 of tubular section 20 cannot pass beyond point 45 of the inner stop 43; and (b) a locking mechanism such that when section 40 is rotated onto threaded section 34, it functions to lock tubular section 20 in place, when tubular section 20 is present in the assembly.

Cylindrical sections and cylindrical tubes are highly suitable to practice the invention. But, it should be understood that the external shape of the sections need not be cylindrical and that different shaped sections (e.g., triangular or rectangular tubular structures) could be used to practice the invention.

Cap 50 of FIG. 1 is also shown in the conceptual cross section drawing of FIG. 1E. Cap 50 may be described as having a horizontal portion 51 and a vertical portion or wall 53 extending (down in FIG. 1E) in a generally perpendicular direction to the horizontal portion 51. Cap 50 has an inner threaded region 52 which is designed to mesh with outer threaded section 15 of base section 10 (see FIG. 1E1). Note: The inner diameter of region 52, identified as D3, is designed to mesh with the outer diameter of base cylindrical section 10. Cap 50 has a second threaded region 62 designed to mesh with threaded section 25 of tubular section 20 (see FIG. 1E2). Cap 50 can thus be directly and easily mated with tubular sections having different diameters. This enable a single cap to mesh with either: (a) base section 10 and (b) extendable tubular section member 20.

Cap 50 also has a multiplicity of threaded holes 54 formed through the vertical walls 53 and generally perpendicular to the vertical walls. The threaded holes enable the attachment of selected accessories such as goosenecks, articulating arms, clamps and various adaptor nuts and bolts to support lights, microphones, monitors, video, etc. . . . . The threaded holes 54 by enabling selected accessories to be attached to the extendable support apparatus increases the benefits of its use. The threaded holes function as dedicated connecting ports. In keeping with the invention, any suitable attachment means could also be used.

Cap 50 also includes a screwable attachment 56 for connection to a camera or any other suitable piece of equipment positioned above cap 50. It is the extendable support provided for the equipment which is the prime goal of the extendable support apparatus embodying the invention.

In one embodiment, 8 threaded holes 54 were formed around the periphery of Cap 50. Cap 50 was designed so it could mate (mesh) with 2 tubular sections having different diameters. It should be appreciated that a cap 50 can be formed with more than 2 different inner diameter tubular sections. The innovative cap with threaded holes and the different inner diameter regions provides a high degree of flexibility which results in a very useful and efficient structure.

FIG. 1F is an isometric drawing showing the components of support apparatus 100 assembled with the least amount of extension. Tubular section 20 extends through and within cylindrical sections 10 and 30 which are screwed together. Collar 40 has been rotated to hold tubular section 20 in place. Cap 50 is mounted on, and secured to, section 20 and the attaching screw mechanism 56 enables the attachment of a selected piece of equipment. Selected accessories can be attached to threaded holes 54 of cap 50.

FIG. 2 is an isometric diagram of the cap 50 screwed onto a base cylinder 10 mounted on a base 200 and FIG. 2A is a cross sectional diagram of FIG. 2. In this configuration the base cylinder 10 mounted on base 200 can provide a fixed extension, approximately equal to the length L1 of base cylinder 10, to any equipment attached to the cap 50 via screw attachment 56 and/or via threaded screw holes 54.

FIG. 3 is a cross sectional diagram of the extendable support device 100 (as shown in FIG. 1F) embodying the invention with tubular support section 20 located on base cylinder 10.

FIG. 4 is a cross sectional diagram of the extendable support device embodying the invention with tubular support section 20 fully extended and locked into place by collar-lock mechanism of section 40.

It should be appreciated that in accordance with the embodiments shown in FIGS. 1F, 2, 2A and FIGS. 3 and 4, the components used to form extendable support apparatus 100 can be used to provide a combination of fixed and varying extensions, as follows: (A) using base cylinder section 10 with cap 50 a fixed extension of approximately L1 can be provided; (B) Using the tubular section 20 with cap 50 as shown in FIG. 1F, a fixed extension of approximately L2 can be provided; and (C) by extending tubular section through cylinder sections 10 and 30, where cylinder section has a length L3; the cap 50 can be raised incrementally from L2 to a distance approximately equal to L1 plus L3 plus L2.

In a particular embodiment, the length of base cylinder 10 was 3 inches which provided a fixed extension of approximately 3 inches for cap 50. With a tubular support 20 having a height of 6½ inches, a cap 50 was extendable from 6½ inches to approximately 10½ inches.

The extendable support of the invention thus solves a significant problem for photographers doing close-up photography such as used in food photography, macro and product photography who need to hold their cameras at various heights depending upon the size and the desired magnification of the object being photographed.

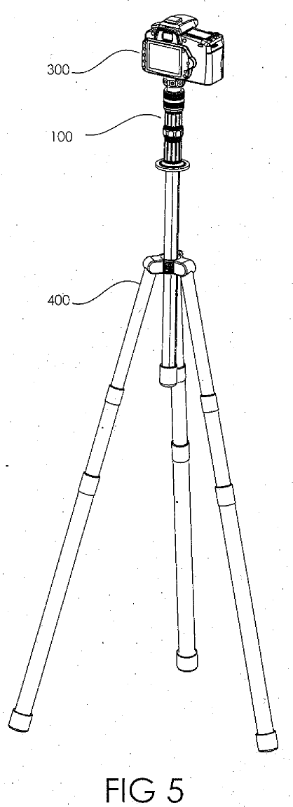

FIG. 5 shows the extendable support 100 mounted on a tripod 400 with a camera 300 mounted on support 100. It is obvious that any other piece of equipment could be used instead of camera 300.

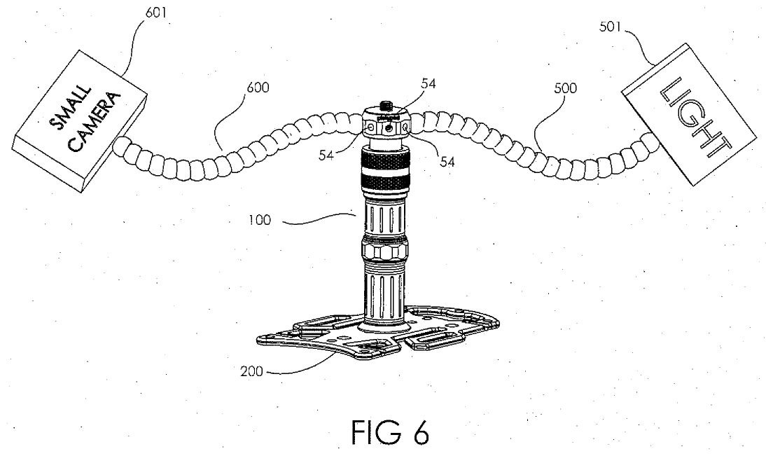

FIG. 6 shows gooseneck connectors, 500 and 600, that have suitable screw heads to mesh with the sized threaded screw holes 54. Connector 500 connects an accessory, light source 501, to a threaded hole 54 in cap 50 and connector 600 connects another accessory, small camera 601, to a threaded hole 54 in cap 50. Cap 50 is shown mounted on extendable support 100 which in turn is mounted on a base 200.

It should be appreciated that, in accordance with the invention, the extendable support 100 may be in any of the fixed or variably extended conditions discussed above.

The invention has been illustrated with base section 10, extension/tubular section 20, additional section 30 being cylindrical. It should be appreciated that these sections need not be cylindrical, so long as they can be stacked and move relative to each other and be locked in any desired position.

The invention has been illustrated with threaded holes (connecting ports) formed in cap section 50 for connecting to selected accessories. It should be appreciated that any suitable hole or attaching means could be used instead. The holes have also been shown to be formed perpendicularly to the side walls of the cap. It should be appreciated that the holes or attaching means may be formed in any suitable manner, horizontally aged even vertically by extending the cap horizontally.

It is significant that Applicants' invention resides in part in a cap section with different sized inner regions which can mate with items of different cross-section and also includes attaching means (holes 54) for the connection thereto of selected accessories.

What is claimed is:

1. Support apparatus for selected equipment comprising:
a support member having a bottom region and a top region; said bottom region including an attaching structure for attaching said support member to an underlying base; and
a cap adapted to mate with said top region of said support member, said cap having a horizontal portion and a vertical portion extending generally perpendicularly to said horizontal portion, said cap having: (a) at least one dedicated port formed within said cap for the connection thereto of selected accessories; and (b) attachment apparatus located along the horizontal portion of the cap for enabling the attachment of said selected equipment thereto.

2. The support apparatus as claimed in claim 1,
wherein said support member includes a base section having an inner cross sectional area and a tubular section having a smaller outer cross sectional area than that of the base section, and said tubular section being adapted to be disposed within said base section and to move smoothly through said base section; and
wherein said dedicated port is a hole and wherein said cap has first and second inner regions of different cross sectional areas, the first region for mating with the base section and the second region for mating with the tubular section.

3. The support apparatus as claimed in claim 2, wherein said support member also includes an additional section, of similar cross sectional area as the base section, which is mountable atop said base section; wherein said base section has a length L1, said tubular section has a length L2, said additional section has a length L3, and where L2 is greater than L1 plus L3;
wherein said tubular section is adapted to be disposed within said base section and said additional section; said tubular section being moveable up and down within said base and additional sections so as to be incrementally extendable, for virtually its full length, beyond the lengths of the combined base and additional sections; and
said support member also including a locking mechanism section coupled between said tubular section and said additional section for locking the tubular cylindrical section in a selected position.

4. The support apparatus as claimed in claim 2, wherein said base section is cylindrical having an inner diameter D1 and having a threaded region about its upper end; and wherein the lower end of the base section corresponds to the bottom region of said support member, wherein said tubular section is cylindrical having an outer diameter D2, where D2 is less than D1 and having a threaded region about its upper end; and wherein said first and second inner regions of said cap are inner threaded regions having different diameters, the first inner threaded region of the cap for mating with the threaded region of the base section and the second inner threaded region of the cap for mating with the threaded region of the tubular section.

5. The support apparatus as claimed in claim 4, wherein the hole formed in the cap for connection to accessories is a threaded hole and is formed within the vertical portion of the cap.

6. The support apparatus as claimed in claim 4, wherein said support member also includes an additional section which is cylindrical and mountable atop said base section, said additional section having a lower end and an upper end defining a length L3, where L3 may be less, equal to, or greater than L1 and having an inner diameter which may be equal to or greater than D1; and
wherein the length L2 of said tubular section is greater than L1 plus L3; said tubular section adapted to be disposed within said base section and said additional section so as to be moveable up and down within said base and additional sections and being incrementally extendable for virtually its full length beyond the lengths of the combined base and additional cylindrical sections; and
wherein said support member also includes a locking mechanism section located between said tubular section and said additional section for locking the tubular section in a selected position.

7. The support apparatus as claimed in claim 6 wherein said cap has first and second inner regions of different diameters, the first inner region for mating with the base section and the second inner region for mating with the tubular section.

8. The support apparatus as claimed in claim 6 wherein said base section has an outer threaded region near its top end; wherein said tubular section has an outer threaded region near its top; and wherein said first inner region of said cap is threaded to mesh with the corresponding threaded section of the base cylindrical section and said second region of said cap is threaded to mesh with the corresponding threaded section of the tubular cylindrical section.

9. The support apparatus as claimed in claim 6 wherein said locking mechanism is located on top of the upper end of the additional cylindrical section and further including a stop for stopping the tubular section from exiting from the additional cylindrical section.

10. The support apparatus as claimed in claim 1 wherein said support member includes a base cylindrical section of inner diameter D1 and a tubular cylindrical section of outer diameter D2, where D2 is less than D1; and
wherein said dedicated port is a hole and wherein said cap has first and second inner regions of different diameters, the first inner region for mating with the base cylindrical section and the second inner region for mating with the tubular cylindrical section.

11. The support apparatus as claimed in claim 10, wherein said tubular cylindrical section is insertable within said base cylindrical section and extendable through it; and wherein said base cylindrical section and said tubular cylindrical section each have a top end and an outer threaded region near its respective top end; wherein said first inner regions of said cap is threaded to mate with the corresponding threaded section of the base cylindrical section; and wherein said second inner regions of said cap is threaded to mate with the corresponding threaded section of the base cylindrical section.

12. An extendable support apparatus comprising:
a base section, a tubular section, an intermediate section, a locking mechanism section, and a cap section;
said base section having a top end and a bottom end and said intermediate section a top end and a bottom end and said base and intermediate sections having similar inner cross-sectional areas and said tubular section having an outer cross-sectional area which is less than the inner cross-sectional areas of the base and intermediate sections;
said base section having a length L1, said intermediate section having a length L3, where L3 can be smaller, equal to or greater than L1, an said tubular section having a length L2 equal to or greater than L1 plus L3;
said base section and said intermediate section being stackable one above the other, with the top end of the base section mating with the bottom end of the intermediate section;
said tubular section being placeable within the base and intermediate sections and designed to move smoothly up and down within and along said base and intermediate sections;
said locking mechanism section being mounted between the intermediate section and the tubular section for selectively locking the tubular section in a selected position; and
said cap section having first and second interior regions, the first interior region for mating the cap with the tubular section and the second interior region for mating the cap with said base section, and wherein said cap includes at least one dedicated port for the connection thereto of selected accessories and attachment apparatus for connection to selected equipment.

13. The extendable support apparatus as claimed in claim 12, wherein said cap section may be characterized as having a horizontal portion and a vertical portion extending perpendicularly to said horizontal portion; and wherein said at least one dedicated port is a threaded hole formed in and through said vertical wall of said cap and wherein said attachment apparatus is formed in and along the horizontal portion of said cap section.

14. The extendable support apparatus as claimed in claim 13 wherein said threaded hole is designed to receive selected accessories such as goosenecks, articulating arms, clamps and various adaptor nuts and bolts to support lights, microphones, monitors, and video apparatus; and wherein said attachment apparatus is for connection to a designated piece of equipment such as a camera.

15. The extendable support apparatus as claimed in claim 12 wherein said base, intermediate and tubular section ions are cylindrical, with the base and intermediate sections having an inner diameter D1 and said tubular section having an outer diameter D2 smaller than D1; and wherein said base section and said tubular have top regions which are threaded; and wherein said cap section has an horizontal portion and a vertical portion extending generally perpendicularly to said horizontal portion, wherein said at least one dedicated port is a hole is formed within said vertical portion, and wherein said first and second interior regions of said cap are threaded for mating with the base section and the tubular section.

16. The extendable support apparatus as claimed in claim 15 wherein a multiplicity of holes are formed within the vertical portion of the cap section to enable a multiplicity of accessories to be connected to the cap section.

17. A kit for selectively forming an extendable support apparatus for selected equipment comprising:
a base section having a bottom end and a top end, with an attachment mechanism along its bottom end for attachment to an underlying base structure and having a cylindrical threaded region of diameter D1 near its top end; said base section having a length L1;
a movable tubular section having a bottom end and a top end with a length L2 greater than L1 and having an outer diameter D2 which is less than D1; said movable tubular section being insertable within said base section for moving smoothly up and down along and within said base section;
a locking mechanism for selectively locking the moveable tubular section in a selected position; and
a cap section including:
(a) attachment apparatus for connecting said selected equipment;
(b) a hole formed within the cap for the connection thereto of selected accessories; and
(c) first and second threaded regions formed within an interior portion of the cap section, said first and second inner threaded regions having different diameters for enabling the mating of the cap section with either the base section or the moveable tubular section.

18. A kit for selectively forming an extendable support apparatus as claimed in claim 17, further including an intermediate section of cylindrical shape having a length L3, where L3 Can be smaller, equal to or greater than L1 and having an inner diameter approximately equal to D1; and wherein the length L2 of the movable cylindrical section is equal to or greater than L1 plus L3.

19. A kit for selectively forming an extendable support apparatus as claimed in claim 18, wherein said locking mechanism is connectable between said intermediate section and said moveable section for selectively locking the moveable tubular section in a selected position.

20. A kit for selectively forming an extendable support apparatus as claimed in claim 19, wherein a multiplicity of threaded holes are formed within the cap section for enabling the connection of multiple selected accessories.
